(19) United States
(12) Patent Application Publication
(10) Pub. No.: US 2006/0208660 A1
(43) Pub. Date: Sep. 21, 2006

(54) Inverter unit for vehicle

(75) Inventors: Osamu Shinmura, Toyota-shi (JP); Tatsuyuki Uechi, Toyota-shi (JP)

Correspondence Address: OLIFF & BERRIDGE, PLC, P.O. BOX 19928, ALEXANDRIA, VA, 22320, US

(73) Assignees: TOYODA JIDOSHA KABUSHIKI KAISHA, TOYOTA-SHI (JP); AISIN AW CO., LTD., ANJO-SHI (JP)

(21) Appl. No.: 11/366,659

(22) Filed: Mar. 3, 2006

(30) Foreign Application Priority Data
Mar. 18, 2005 (JP) 2005-078987

(51) Int. Cl. H05B 37/02

(52) U.S. Cl. 315/209 R

(57) ABSTRACT

An inverter unit for vehicle (20) is formed in such a manner that a capacitor module (40) is stacked on the upper portions of a main inverter circuit module (32) and a sub inverter circuit module (34) so as to connect the corresponding external terminals by a bolt (66). Here, by matching a positive electrode terminal (44) and a negative electrode terminal (46) of the capacitor module (40) with a positive side electrode terminal (45) and a negative side electrode terminal (47) of the main inverter circuit module (32), and at the same time by matching a positive electrode terminal (48) and a negative electrode terminal (50) of the capacitor module (40) with a positive side electrode terminal (49) and a negative side electrode terminal (51) of the sub inverter circuit module (34), responsible terminals are connected with this bolt (66) each other.

### CROSS-REFERENCE TO RELATED APPLICATION

The entire disclosure of Japanese Application No. 2005-078987 including the specification, claims, drawings, and abstract are incorporated herein by reference.

### BACKGROUND OF THE INVENTION

1. Field of the Invention

The present invention relates to an inverter unit for vehicles, and particularly, the present invention relates to an inverter unit for a vehicle which includes an inverter circuit module and a smoothing capacitor.

2. Description of the Related Art

Vehicles having a motor/generator, such as hybrid vehicles, are normally equipped with a power control unit (PCU) including an inverter circuit. Such a PCU includes a DC power source such as a battery, an inverter circuit for DC/AC conversion, a smoothing capacitor for suppressing pulsation of DC power supply, and a boost converter provided as required or desired. In many cases, these components are connected by a connection wire, a so-called bus bar.

In order to effectively suppress a surge voltage generated upon switching from a switching element in the inverter circuit, it is desirable that impedance due to connection between the smoothing capacitor and the inverter circuit be suppressed to as small a value as possible. In consideration of this problem, Japanese patent laid open publication 2003-116281 discloses a structure in which an inverter circuit module, a capacitor module, and a DC power source module are installed in a different casings, a pair of circuit terminals is arranged on the surface of the casing of the inverter circuit module, and the capacitor module has two pairs of electrodes integrally attached to that casing, wherein one pair is directly bonded to each circuit terminal of the inverter circuit module by a bolt and the other pair is directly connected to a power supply terminal of the DC power source module by a bolt. In other words, in this example, without using a bus bar, which generally tends to be relatively long, the inverter circuit module, the capacitor module, and the DC power source module are directly connected with each other. Further, the capacitor module is three-dimensionally arranged so as to be piled up directly above the inverter circuit module.

Similarly, in Japanese patent laid open publication 2000-92847, a DC input terminal of a semiconductor module including a power semiconductor circuit is elongated directly above an electrode terminal with a screw of a capacitor that is arranged at the side of the semiconductor module. Thereby, it is disclosed that the electrode terminal of the capacitor and the DC input terminal of the semiconductor module are directly connected by the screw without using the bus bar. According to this example, the semiconductor module and the capacitor are arranged side by side two-dimensionally.

Thus, according to the existing art, each element of the PCU is made into a module, and further, among these modules, the inverter circuit is connected to the capacitor at the shortest distance.

For some vehicles, a plurality of inverter circuit modules must be provided. For example, it is not uncommon for a single vehicle to be offered in both front-wheel drive and four-wheel-drive versions. In this case, for the front-wheel drive version (sometimes referred to as the “front-engine front-drive” version), two inverter circuits are normally provided in one inverter circuit module, and each circuit is used for driving the power train and braking/generating power. Then, for the four-wheel drive model, an additional inverter circuit for driving the rear wheels may be added. In such a case, in addition to a set of the inverter circuit module and the capacitor for the front-engine front-drive vehicle, another set of an inverter circuit and capacitor are necessary. In addition, an inverter circuit and capacitor may be also provided for an air conditioner, and prepared separately from the components used for driving a vehicle.

Thus, in a vehicle, a plurality of sets of inverter circuits and capacitors may be provided. However, when each set is independent and the inverter circuit is connected to the capacitor at the shortest distance, as in the existing art, the volume required for these plural sets is large, which increases the size and manufacturing cost of the vehicle.

### SUMMARY OF THE INVENTION

In consideration of the above, the present invention advantageously provides an inverter unit for vehicle (an inverter unit installed on or used in conjunction with vehicles), which can decrease impedance between an inverter circuit and a capacitor when a plurality of sets of the inverter circuit and the capacitor is necessary for vehicle and can entirely downsize the inverter unit. Here, a connected inverter circuit and a capacitor is referred to as an inverter unit.

The inverter unit for a vehicle according to the present invention may comprise a plurality of inverter circuit modules having a positive side electrode terminal and a negative side electrode terminal as an external terminal, and a common smoothing capacitor, which is a smoothing capacitor having plural pairs of positive electrode terminals and negative electrode terminals as external terminals, wherein each of respective positive electrode terminals and respective negative electrode terminals is branched from a positive electrode and a negative electrode of an internal element of the smoothing capacitor into plural terminals, respectively, so that each of positive electrode terminals and each of negative electrode terminals are detachably connected to each of positive side electrode terminals and each of negative side electrode terminals of plural inverter circuit modules, respectively. Here, the inverter circuit module is what includes one or more inverter circuits to be made into one module.

In addition, in an inverter unit according to the present invention, it is often preferable that each external terminal of the common smoothing capacitor be arranged at a height position corresponding to the height of the external terminal of each inverter circuit module.

Further, in an inverter unit according to the present invention, it may be preferable that the common smoothing capacitor is an approximately rectangular solid, and one pair of external terminals corresponding to the external terminal of each inverter circuit module is arranged on each side of the common smoothing capacitor.

Further, it may be preferable that a plurality of inverter circuit modules includes a main inverter circuit module to be used for driving power and power generating of a front-wheel drive of vehicle and a sub inverter circuit module to be used for driving power of a rear-wheel drive of vehicle in the inverter unit for vehicle according to the present invention.

With the above structures employing the common smoothing capacitor for a plurality of inverter circuit modules, the common smoothing capacitor has plural pairs of positive electrode terminals and negative electrode terminals as an external terminal. Then, each of positive electrode terminals and each of negative electrode terminals are branched from the positive electrode terminal and the negative electrode terminal of the inner element of the smoothing capacitor into plural terminals, respectively. In other words, respective positive electrode terminals are equal with each other, as are respective negative electrode terminals. Then, each of positive electrode terminals and each of negative electrode terminals of the smoothing capacitor are detachably connected to each of positive side electrode terminals and each of negative side electrode terminals of plural inverter circuit modules. Accordingly, it is possible to decrease impedance between the inverter circuit and the capacitor and thereby decrease the overall size of the configured device.

In addition, each external terminal of the common smoothing capacitor is arranged at a height position corresponding to the height of the external terminal of each inverter circuit module, so that respective external terminals corresponding to the inverter circuit modules having different shapes and outlines can be connected to each other by, for example, simple direct connection.

Further, when the common smoothing capacitor is an approximately rectangular solid, and one pair of external terminals corresponding to the external terminal of each inverter circuit module may be arranged on each surface or side of the rectangular solid. Thereby, it is possible to effectively arrange each inverter circuit module to the common smoothing capacitor two-dimensionally.

In addition, a plurality of inverter circuit modules may include a main inverter circuit module to be used for driving power to and power generating from the front wheels of vehicle and a sub inverter circuit module to be used for driving power to the rear wheels of the vehicle. As a result, for example, the four-wheel-drive vehicle can be used with the main inverter circuit module and the sub inverter circuit module connected with each other and the front-engine front-drive vehicle can be used with the sub inverter circuit module detached. In other words, the same design can be easily applied to both four-wheel drive and front-wheel drive vehicles.

As described above, by employing the inverter unit for vehicle of the present invention, when plural sets of inverter circuits and capacitors are needed for a vehicle, it is possible to decrease impedance between the inverter circuit and the capacitor and reduce the overall size of the components and of the vehicle.

### BRIEF DESCRIPTION OF THE DRAWINGS

FIG. 1 is a view showing a power control unit (PCU) used for a four-wheel drive vehicle, two electric motors, and one generator, for explaining the manner in which an inverter unit is included in the PCU according to an embodiment of the present invention;

FIG. 2 is a view showing an inner structure of a capacitor module according to the embodiment of the present invention;

FIG. 3 is a view explaining the structure of a film capacitor element of a prior art through an example manufacturing method thereof;

FIG. 4 is a perspective view of an inverter unit for vehicle according to the embodiment of the present invention; and

FIG. 5 is a side view of an inverter unit for vehicle according to the embodiment of the present invention.

### DETAILED DESCRIPTION OF THE INVENTION

A preferred embodiment of the present invention will be described below with reference to the drawings. Although in the following explanation, it is assumed that an inverter unit for a vehicle is configured by two inverter circuit modules and one capacitor module, more than two inverter circuit modules may be provided. For example, in addition to a main inverter circuit module to be used for driving power to and electric power generation from the front-wheel drive vehicle and a sub inverter circuit module to be used for driving power to a rear-wheel drive vehicle, an inverter circuit module for air conditioner or the like, to which a voltage or the like is adapted, can be connected to the vehicle-mounted inverter unit. In addition, the installation locations for each external terminal are described below as an illustrated example, and other locations may be used as long as the inverter circuit module can be connected to the capacitor module.

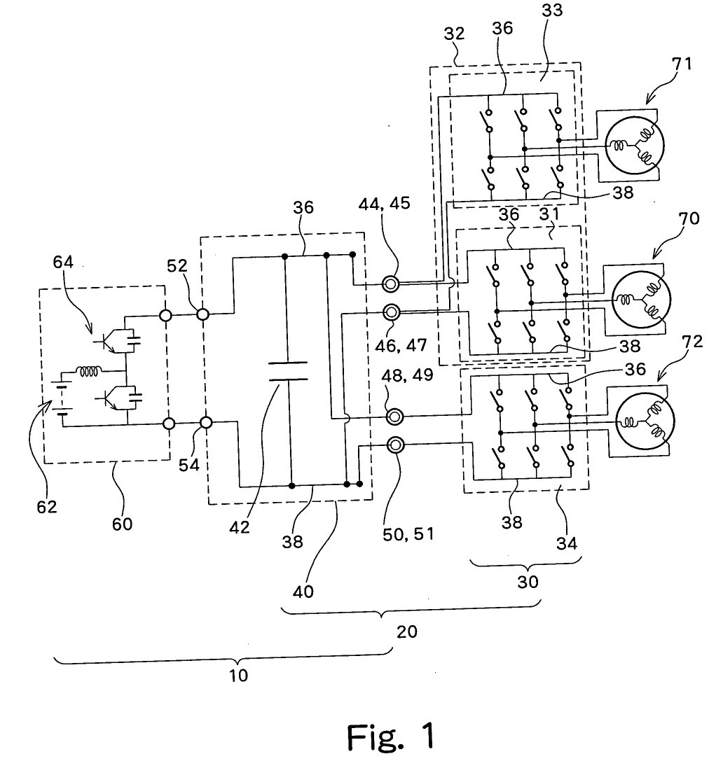

FIG. 1 is a block diagram showing a power control unit (PCU) 10 to be used for a four-wheel drive vehicle, two electric motors 70 and 72, and one generator 71. Here, in the PCU 10, an inverter unit 20 for vehicle is included. The electric motor 70 is used to drive the front wheels, the generator 71 serves for braking and power generation, and the electric motor 72 drives the rear wheels.

The PCU 10 is a electric power control unit installed on a vehicle, which is configured by the inverter unit 20 for vehicle, including an inverter circuit module 30 and a capacitor module 40, and a direct current power source 60. The PCU 10 has a function to convert a direct current (DC) into an alternating current (AC) and supply the AC current to the two electric motors 70 and 72 or the like while maintaining a direct current power from the direct current power source 60 in a common smoothing capacitor 42. In this case, the inverter circuit module 30 is configured by a main inverter circuit module 32 including a front-wheel drive inverter circuit 31 and a braking/generating power inverter circuit 33 corresponding to the electric motor 70 and the generator 71, respectively; and a sub inverter circuit module 34 including a rear-wheel drive inverter circuit corresponding to the electric motor 72. In addition, the direct current power source section 60 includes a direct current power source 62 and a reactor-type boost converter 64.

Each of the inverter circuit modules 32 and 34 is made into one module by housing a known inverter circuit in a casing. Here, in case of vehicle driving by power means, for example, the inverter circuit is a high speed switching circuit, which has a function to switch a direct current signal at a predetermined timing using a switching element and convert the signal into a three-phase AC signal of U, V, and W phases of the electric motors 70 and 72 and the generator 71. Respective inverter circuits 31 and 33 included in the main inverter circuit module 32 and the inverter circuit configuring the sub inverter circuit module 34 are provided with an external terminal to be connected to the capacitor module 40, in addition to the terminals to be connected to the U, V, and W phases of the corresponding electric motors 70 and 72 and generator 71.

In other words, in each of the inverter circuit modules 32 and 34, a positive side power line 36 and a negative side power line 38 of each inverter circuit are extended out onto the surface of the casing as external terminals. Here, the positive side power line 36 is connected to a high potential side of the direct current power source section 60 when it is connected to the direct current power source section 60 via the common smoothing capacitor 42, and the negative side power line 38 is connected to a low potential side of the direct current power source section 60 in the same connection. For example, in two positive side power lines 36 and two negative side power lines 38 of the main inverter circuit module 32, for example, two lines having the same polarity are joined by extending them out onto the surface of the casing as a positive side electrode terminal 45 and a negative side electrode terminal 47. In a similar manner, the positive side power lines 36 and the negative side power lines 38 of the sub inverter circuit module 34 are pulled out into the surface of the casing as a positive side electrode terminal 49 and a negative side electrode terminal 51, respectively. A detailed example of the arrangement on the casing will be described below.

The capacitor module 40 may house the common smoothing capacitor 42 to be shared by two inverter circuit modules 32 and 34 in the casing to be made into one module. The capacitor module 40 is provided with two pairs of external terminals to be connected to each external terminal of respective inverter circuit modules 32 and 34 by binding in addition to one pair of external terminals to be connected to the direct current power source section 60.

In other words, the positive side power line 36 and the negative side power line 38 of the common smoothing capacitor 42 may be branched into three lines. Here, as explained for the inverter circuit module 30, the positive side power line 36 is the power line to be connected to the high potential of the direct current power source section 60 and the negative side power line 38 is the power line to be connected to the low potential of the direct current power source section 60 when they are connected to the direct current power source section 60. One set of ends among three sets of branched lines is extended out from the casing of the capacitor module 40 as a positive electrode terminal 52 and a negative electrode terminal 54 to be connected to the high potential side and the low potential side of the direct current power source section 60.

The ends of the leftmost two branches of the positive side power line 36 of the common smoothing capacitor 42 as illustrated are extended out from the surface of the casing of the capacitor module 40 as a positive electrode terminal 44 corresponding to the positive side electrode terminal 45 of the main inverter circuit module 32 and as a positive electrode terminal 48 corresponding to the positive side electrode terminal 49 of the sub inverter circuit module 34, respectively. In a similar manner, the ends of the leftmost two branches of the negative side power line 38 of the common smoothing capacitor 42 are extended out from the surface of the casing of the capacitor module 40 as a negative electrode terminal 46 corresponding to the negative side electrode terminal 47 of the main inverter circuit module 32 and as a negative electrode terminal 50 corresponding to the negative side electrode terminal 51 of the sub inverter circuit module 34, respectively. A detailed example of the arrangement of each external terminal will be described below.

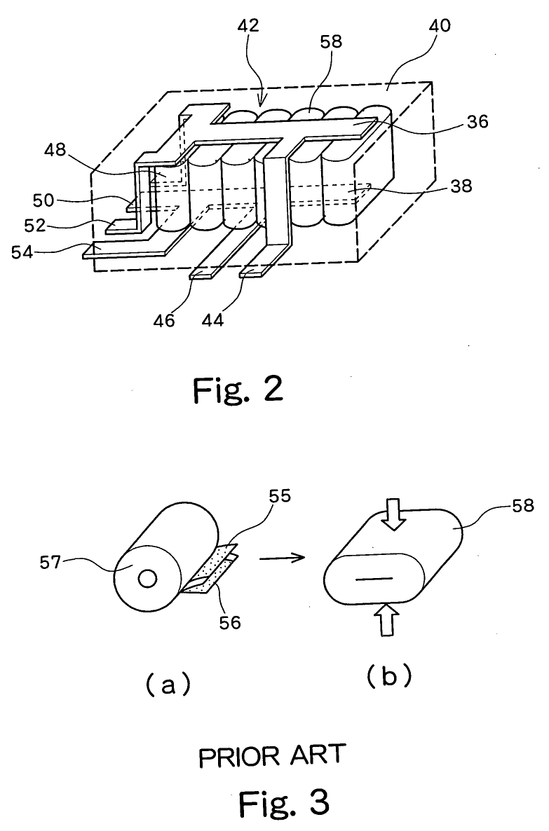

FIG. 2 is a view showing the inner structure of the capacitor module 40. The capacitor module 40 houses the common smoothing capacitor 42, is configured by aligning and arranging a plurality of film capacitor elements 58, and the electrodes at a certain sides of respective film capacitor elements 58 are connected with each other by a common conductor, to thereby form the positive side power line 36. In a similar manner, the electrodes at the other sides of respective film capacitor elements 58 are connected with each other by a common conductor, to thereby form the negative side power line 38. The electrode at one side of the film capacitor element 58 may be called a positive electrode and the electrode at the other side of the film capacitor element 58 may be called a negative electrode.

FIGS. 3 is a view explaining the structure of the film capacitor element 58 byway of an example of a manufacturing method thereof. As shown in FIG. 3(a), in order to manufacture the film capacitor element, at first, by winding two metallized films 55 and 56 around a roll core, a half finished product 57 having an approximately circular cross-section is manufactured. For example, the metallized film is made in such a manner that a plastic film such as a polypropylene film is used as a dielectric body and a metal layer as a capacitor electrode is formed on one side of the plastic film by vapor deposition or the like. Tag electrode portions are provided from the end portions of respective metallized films 55 and 56. The tag electrode portions of respective metallized films 55 and 56 are provided so as to be the end portions at opposite ends of the metallized films. Accordingly, the opposite ends in the axial direction of the half finished product 57 having approximately the circle section are made into the tag electrode portions, respectively. Next, as shown in FIG. 3(b), by drawing out the rolling core of the half finished product having the circle section and then pressurizing as indicated in the figure by an arrow, a cavity of the drawn out rolling core is crushed to create a section of an oval flat shape. After that, the film capacitor element 58 is formed by using a Zn melting injection technology or the like to form opposite axial ends into electrodes. A determined numbers of thus-manufactured film capacitor elements 58 are then aligned, arranged, and connected in parallel. As a result, the capacitor module 40 having a desired capacity can be obtained.

Returning to FIG. 2, the positive side power line 36 and the negative side power line 38 of the capacitor module 40 are branched into three lines as described above and respective ends are drawn out from the casing of the capacitor module 40 so as to be made into six external terminals.

As shown in FIG. 2, the positive side power line 36 is an upper electrode plate that is arranged with the electrode parts of certain sides of a plurality of film capacitor elements 58 connected thereto. The upper electrode plate of this positive side power line 36 is branched in a lateral direction at nearly its center portion, the branched line is curved downward along one side face of the capacitor module 40 and toward the external side in the vicinity of the bottom face of the capacitor module 40 so as to form the positive electrode terminal 44. In addition, the upper electrode plate of this positive side power line 36 is branched into two lines at the upper end, the branches are bent downward along a side face that is different from the side face of the capacitor module 40 on which the positive electrode terminal 44 is arranged, and further the branches bend toward the external side in the vicinity of the bottom face of the capacitor module 40, so as to form the positive electrode terminals 48 and 52.

The negative side power line 38 is a lower electrode plate that is arranged with the electrode parts of the other sides of a plurality of film capacitor elements 58 connected thereto. The lower electrode plate of this negative side power line 38 is branched in a lateral direction in parallel with the positive electrode terminal 44 at intervals at nearly its center portion, and the branched line is extended out toward the external side in the vicinity of the bottom face of the capacitor module 40 so as to form the negative electrode terminal 46. In addition, the lower electrode plate of this negative side power line 38 is branched into two at the side face of the capacitor module 40 on which the positive electrode terminals 48 and 52 are arranged and they are extended out to the outside respectively so as to form the negative electrode terminals 50 and 54, respectively. Here, the branched lines are made to be in parallel with the positive electrode terminals 48 and 52 at intervals with each other.

Thus, as the external terminal, one set of a positive electrode terminal 44 and a negative electrode terminal 46 is arranged at the bottom face side of one side face of the capacitor module 40. At the bottom face side of the other side face of the capacitor module 40, two sets, namely, the set of the positive electrode terminal 48 and the negative electrode terminal 50 and the set of the positive electrode terminal 52 and the negative electrode terminal 54 are arranged. Further, any other branches of the upper electrode plate and the lower electrode plate and any other method of drawing out may be employed. Further, in these three sets of external terminals, the positional relations in the height direction may differ from each other.

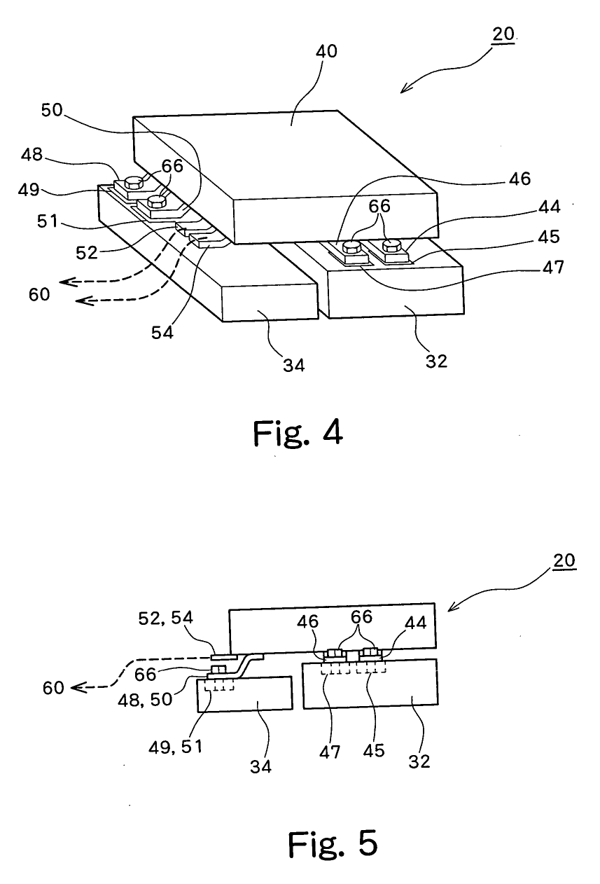

FIG. 4 and FIG. 5 are a perspective view and a side view of the inverter unit 20 for vehicle, respectively. The inverter unit 20 for vehicle is formed in such a manner that the capacitor module 40 is piled upon the upper parts of the main inverter circuit module 32 and the sub inverter circuit module 34 so as to connect the corresponding external terminals by a volt 66. As described above, the main inverter circuit module 32 serves for a front-wheel driving by power means and braking/generating power and the sub inverter circuit module 34 serves for a rear-wheel drive by power means. Therefore, the sub inverter circuit module 34 has a slightly smaller outline than that of the main inverter circuit module 32.

In this case, on the upper surface of the main inverter circuit module 32, the positive side electrode terminal 45 and the negative side electrode terminal 47 are drawn out and embedded at the places of the front side in FIG. 4 to form an electrode plate having a nut hole. Additionally, on the upper surface of the sub inverter circuit module 34, the positive side electrode terminal 49 and the negative side electrode terminal 51 are extended out and embedded at the places of the left side in FIG. 4 as an electrode plate having a nut hole. In addition, on the bottom face of the capacitor module 40, the positive electrode terminal 44 and the negative electrode terminal 46 are extended to the locations shown at the front side in FIG. 4 to form an electrode plate having a through hole which a bolt 66 passes respectively. Additionaly, the positive electrode terminal 48 and the negative electrode terminal 50 are extended to the locations shown at the left side in FIG. 4 to form an electrode plate having a through hole which a bolt 66 passes respectively. Further, at the location of the left side in FIG. 4, the positive electrode terminal 52 and the negative electrode terminal 54 are drawn out.

In these cases, the relative arrangement between the holes of the positive electrode terminal 44 and the holes of the negative electrode terminal 46 is designed to be the same as the relative arrangement between the nut holes of the positive side electrode terminal 45 and the nut holes of the negative side electrode terminal 47 of the main inverter circuit module 32. In other words, by matching the nut hole of the positive side electrode terminal 45 of the main Inverter circuit module 32 with the hole of the positive electrode terminal 44 of the capacitor module 40, it is possible to simultaneously match the nut hole of the negative side electrode terminal 47 of the main inverter circuit module 32 with the hole of the negative electrode terminal 46 of the capacitor module 40.

Further, and similarly, the relative positional relation between the hole of the positive electrode terminal 48 and the hole of the negative electrode terminal 50 of the capacitor module 40 may be made to the same as the relative arrangement between the nut hole of the positive side electrode terminal 49 and the nut hole of the negative side electrode terminal 51 of the sub inverter circuit module 34. Still further, this arrangement may be related with the positional relationship between the capacitor module 40 and the main inverter circuit module 32. In other words, as described above, by matching the positive electrode terminal 44 and the negative electrode terminal 46 of the capacitor module 40 with the positive side electrode terminal 45 and the negative side electrode terminal 47 of the main inverter circuit module 32, respectively, the nut hole of the positive side electrode terminal 49 of the sub inverter circuit module 34 is matched with the hole of the positive electrode terminal 48 of the capacitor module 40. At the same time, it is possible to match the nut hole of the negative side electrode terminal 51 of the sub inverter circuit module 34 with the hole of the negative electrode terminal 50 of the capacitor module 40.

In this way, respective external terminals of the capacitor module 40 are arranged so that they can be connected to respective corresponding external terminals in the main inverter circuit module 32 and respective corresponding external terminals in the sub inverter circuit module 34, respectively, including the two-dimensional arrangement relation and the height arrangement relation by the bolt 66. Further, the left positive electrode terminal 52 and negative electrode terminal 54 that are extended out from the capacitor module 40 are connected to the direct current power source section 60 by using an appropriate wired connection, such as a bus bar.

As a result, by stacking the capacitor module 40 on the upper sides of the main inverter circuit module 32 and the sub inverter circuit module 34 and connecting the external terminals of the capacitor module 40 to the corresponding external terminals using the bolt 66, it is possible to decrease the impedance between the inverter circuit and the capacitor and to decrease the overall size of the inverter unit, which advantageously increases the degree of freedom of installation of the inverter unit on a vehicle. In addition, when a module is desired for a vehicle which does not require an inverter circuit module 34, such as a front-wheel drive (front-engine front-drive) vehicle, it is possible to easily fashion an inverter module which does not include the sub inverter circuit module 34 by simply removing the bolt 66 and disconnecting the capacitor module 40 from the sub inverter circuit module 34.

1. An inverter unit for vehicle comprising:
a plurality of inverter circuit modules having a positive side electrode terminal and a negative side electrode terminal as an external terminal; and
a common smoothing capacitor having plural pairs of positive electrode terminals and negative electrode terminals as external terminals, wherein each of respective positive electrode terminals and respective negative electrode terminals is branched from a positive electrode and a negative electrode of an internal element of the smoothing capacitor into plural terminals, respectively, so that each of positive electrode terminals and each of negative electrode terminals are detachably connected to each of positive side electrode terminals and each of negative side electrode terminals of plural inverter circuit modules.

2. The inverter unit for vehicle according to claim 1,
wherein each external terminal of the common smoothing capacitor is arranged at a height position corresponding to the height of the external terminal of inverter circuit module.

3. The inverter unit for vehicle according to claim 1,
wherein the common smoothing capacitor has an approximately rectangular solid shape, and each pair of external terminals corresponding to the external terminal of each inverter circuit module is arranged on each side surface of the common smoothing capacitor.

4. The inverter unit for vehicle according to claim 1,
wherein a plurality of inverter circuit modules includes a main inverter circuit module to be used for driving power and power generating of the front wheels of the vehicle and a sub inverter circuit module to be used for driving power of the rear wheels of the vehicle.
